(19) United States
(12) Patent Application Publication
(10) Pub. No.: US 2026/0039773 A1
(43) Pub. Date: Feb. 5, 2026

(54) SPOTLIGHT AND NIGHT VISION DEVICE MOUNTING SYSTEM FOR A VEHICLE

(71) Applicant: NightRide Thermal Inc., Brooklyn, NY (US)

(72) Inventors: Shawn Groce, Brooklyn, NY (US); Jacky Yuan, New York, NY (US); Zev Kramer, Brooklyn, NY (US)

(21) Appl. No.: 19/268,523

(22) Filed: Jul. 14, 2025

Related U.S. Application Data
(60) Provisional application No. 63/672,745, filed on Jul. 18, 2024.

(51) Int. Cl. H04N 7/18; B60R 1/28; H04N 23/23; H04N 23/57; H04N 23/62

(52) U.S. Cl. CPC H04N 7/183; B60R 1/28; H04N 23/23; H04N 23/57; B60R 2300/106; B60R 2300/205; H04N 23/62

(57) ABSTRACT

A night vision system includes a thermal radiation night vision device for mounting on a spotlight on an exterior of a vehicle. The night vision device is to detect thermal radiation for objects within line of sight of the vehicle and to create a video with the detected objects. The created video may be communicated to a display device located within an interior region of the vehicle for displaying the video stream to a user driving the vehicle. The system includes an interface to easily and securely replace a portion of a frame of a spotlight mounted to the vehicle in order to secure the thermal radiation night vision device to the spotlight. This system can be powered and controlled via the existing interface originally intended for powering the spotlight. And this system is powered and controlled by the attached handle.

### BACKGROUND

According to the National Safety Council of the United States, the risk of a fatal crash is three times greater at night when it is dark. Depth perception, color recognition and peripheral vision can be compromised in the dark. The nighttime vision issues may increase as we get older. Furthermore, the risk of accidents may increase at night because the driver may be more tired. Moreover, the glare of headlights from an oncoming vehicle can temporarily blind a driver. All of these issues may play a role in the increased fatality rates associated with driving at night.

Night vision systems may be used by drivers at night to see objects in relatively low light conditions. The use of a night vision system may be a possible solution for lowering the risks involved with night driving. Night vision systems may be active or passive systems. Active systems include a light source to shine light (non-visible light) in front of the vehicle, a camera to receive light reflected off any objects and a display to display the reflected light detected. The light source may provide infrared or near infrared light. A passive system does not require the light source. Rather, a camera is designed to detect thermal radiation that is emitted from objects and to display the thermal radiation detected.

Many service vehicles come with an attached user-controlled spotlight that is mounted with a bar through the “A” pillar (frame of front windshield on drivers' side) of the vehicle. The spotlight is articulated by a handle mounted to a side of the bar located internal to the vehicle. The handle also includes a power switch that is used to turn on/off the spotlight. The power is delivered to the handle via a cable connected to the vehicle's battery. The bar delivers the power from the handle to the spotlight, where the delivery of the power is controlled by the switch.

FIG. 1A illustrates an example spotlight mounting system 100 that is often mounted to service vehicles. The system 100 includes a light 110 (e.g., lamp, bulb, LED, projector), a light enclosure 120, an articulating bar 130, a handle 140, a power switch 150 and a power cable 160. The light enclosure 120 holds the light 110 and secures it to the articulating bar 130. The articulating bar 130 acts as a coaxial shaft (e.g., outer shaft is ground and inner shaft provides voltage) and provides power from the handle 140 to the light 110. The power switch 150 controls whether the power is provided to the light 110 (turns on/off the light 110). The power cable 160 connects the handle 140 to the battery to provide power to the handle 140.

FIG. 1B illustrates the example spotlight mounting system 100 mounted to a vehicle. The bar 130 passes through the “A” pillar 190. An external portion of the bar 130 has the frame 120 with the light 110 housed therein mounted to the end thereof. An internal portion of the bar (not visible) has the handle 140 mounted to the end thereof. An operator of the vehicle can turn on/off the light 110 by pressing the power switch 150 on the handle 140 and can move the light 110 (adjust the direction the light 110 is pointed) by moving the handle 140 in order to move the bar 130.

These spotlights are commonly used in the field for viewing in the dark. The spotlights have limitations related to the visibility provided thereby (e.g., range, effect of inclement weather) and also bring attention to the vehicle.

There is a need for service vehicles to be outfitted with a night vision system that could provide additional visibility in the dark to the people in the vehicle. The night vision may provide increased visibility while driving, situational awareness while in the vehicle, security, surveillance, and search and rescue.

Some current night vision systems are intended to be utilized in conjunction with the spotlight and therefore are designed to be mounted to the spotlight. Such night vision systems require a cable connected to the night vision device that can provide both power to the thermal sensor, as well as transmit the signal back to the inside of the vehicle. The separate powering of the night vision device enables it to be operational when the spotlight is off, which may be desirable in certain situations. The cable provided to the night vision system is located external to the bar (and may be secured to the bar). An exposed cable outside of the vehicle isn't ideal for service vehicles as it may be an obstruction and provides a weak point (may be suspectable to outdoor elements including weather, travel, and outside influences). Furthermore, the cable needs to be run through the vehicle firewall in order to get internal to the vehicle to connect to a display device. The added routing of a cable is difficult and could potentially damage the vehicle and/or the cable.

FIG. 2 illustrates an example spotlight and night vision device mounting system 200. The system 200 has many of the same components (light 110, articulating bar 130, handle 140, power switch 150, power cable 160) and also includes a night vision device 210, a light/sensor enclosure 220 and a power/data cable 230. The night vision device 210 may be a night vision camera such as thermal camera or far-infrared camera. The light/sensor enclosure 220 may connect to the light enclosure 130 or may replace a portion of, or the entire, light enclosure 120. The light/sensor enclosure 220 is capable of mounting the night vision device 210 above the light 110. The power/data cable 230 connects to the night vision device 210 and is routed to the interior of the vehicle. The power/data cable 230 provides power to the night vision device 210 and also carries the data and video stream to a display withing the interior of the vehicle.

A spotlight and night vision device mounting system that does not require an external cable or routing of the cable through the vehicle fire wall is desirable. A spotlight and night vision device mounting system where the operation of the light and the night vision device can be controlled together from a single unit is also desirable.

### SUMMARY

Our system consists of a night vision device, processing module, a wireless module and a power control module that attaches to a spotlight, and a handle with a processing device, and an interface, such as a button, switch, or touch device.

The handle with switch used for powering a standard spotlight is replaced with a handle with a first processing device and an interface, such as a button, switch, or touch device. The handle and interface provide power to a second processing device in the spotlight and night vision device enclosure and transmits a signal over the spotlight shaft to the second processing device to turn on and off the spotlight, as well as turn on and off the night vision device.

The second processing device located with the spotlight receives power from the first processing device in the handle, and when it gets the signal from the handle over the same connection as it receives the power, it powers the spotlight. The second processing device can adjust the brightness and intensity of the spotlight, as well as power the spotlight in a continuous mode or as a strobe light.

The night vision device then sends the video stream back to the vehicle via one or more wireless modules, such as Wi-Fi or Bluetooth, so the stream can be viewed by the vehicle inhabitants. This allows the spotlight to be run without a cable installed.

### BRIEF DESCRIPTION OF THE DRAWINGS

For a more complete understanding of the invention, there will now be described some embodiments thereof, given by way of example, reference being made to the accompanying drawings, in which:

FIG. 1A illustrates an example spotlight mounting system.

FIG. 1B illustrates the example spotlight mounting system mounted to a vehicle.

FIG. 2 illustrates an example spotlight and night vision device mounting system including an external cable connected to the night vision device.

FIG. 3 illustrates a block diagram of an example spotlight and night vision device system not requiring cables and allowing control of both via the handle, according to one embodiment.

FIG. 4 illustrates an example spotlight and night vision device mounting system, according to one embodiment.

FIG. 5 illustrates an alternative view of the handle of FIG. 4 with a button user interface visiable, according to one embodiment.

FIG. 6 illustrates a display device mounted in the interior of a vehicle to provide the video of the thermal images captured by the thermal camera to the user, according to one embodiment.

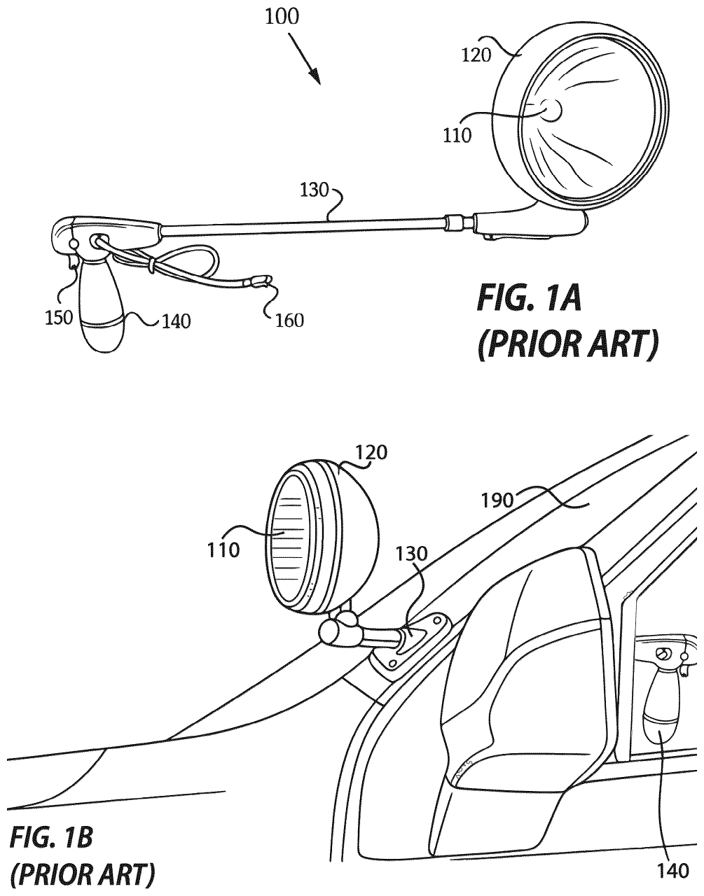

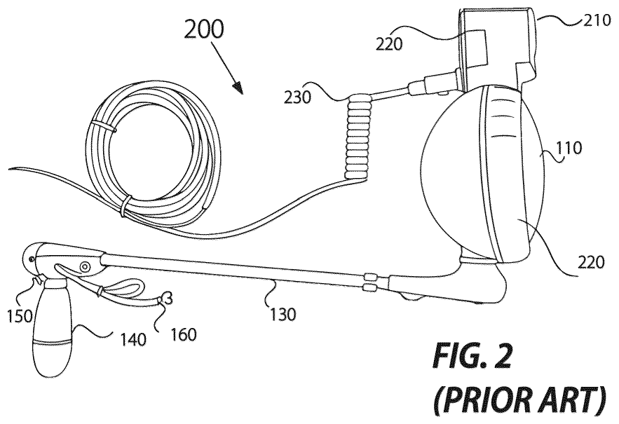

### DETAILED DESCRIPTION

According to one embodiment, power to the night vision device could be provided by the actuating bar 130 in the same fashion as the light 110. This would eliminate the need for an external power cable. However, a cable to provide the information from the night vision device to a display within the vehicle would still be required. According to one embodiment, the night vision device may include a wireless communications interface that can provide the information to a display within the vehicle without the need for a cable. The display device in the vehicle would have to also include a wireless interface. The display device could be anything selected by a user that is cable of displaying the thermal images captured including, but not limited to, a smart phone, a laptop computer, a tablet computer, a heads-up display or a monitor. The display device could be an infotainment system of the vehicle. According to one embodiment, multiple display devices may be utilized.

Utilizing the actuating bar 130 to provide power means that the night vision device would only work when the spotlight is on. Although this could be useful in some scenarios there are many other scenarios where a user may want the night vision on while the spotlight is off. Accordingly, a preferred embodiment would provide the ability to control the night vision device and the spotlight separately. According to one embodiment, each of the devices could be controlled by the handle.

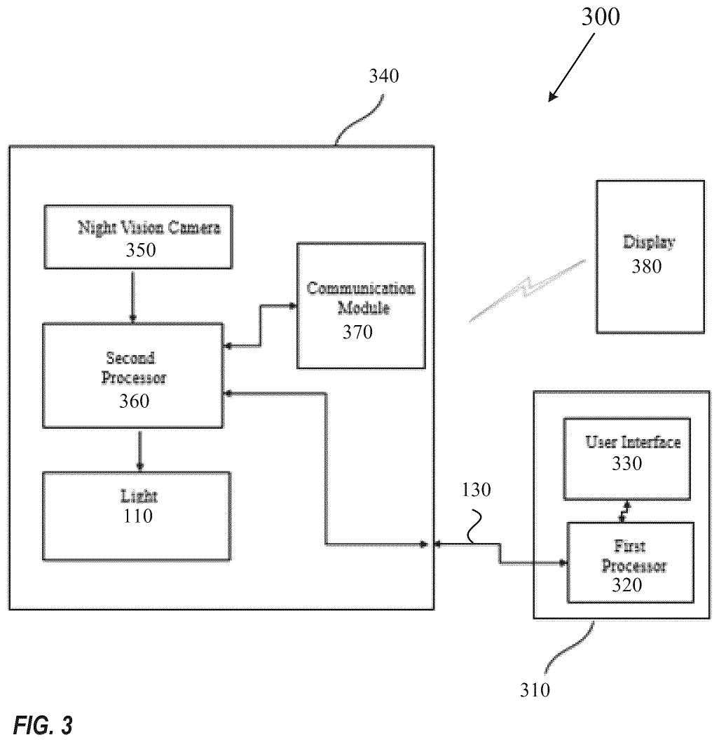

FIG. 3 illustrates a block diagram of an example spotlight and night vision device system 300. The system 300 includes a handle 310, a spotlight/night vision device 340 and a display 380. The handle 310 includes a user interface 330 and a first processor 320. The user interface 330 is to receive commands from a user. The user interface 330 may be, for example, a button, a switch, or a touch device that enables the user to define how the spotlight and night vision device should be operated (to be discussed in more detail later). The first processor 320 receives the commands from the user and sends an appropriate signal to the spotlight/night vision device 340 based thereon. The first processor 320 may adjust the voltage that is provided via the bar 130 (acting as a coaxial shaft) to the spotlight/night vision device 340 based on the commands received from the user. Alternatively, the first processor 320 may provide signals (e.g., pulse width modulation) onto the voltage based on the commands received from the user.

The spotlight/night vision device 340 may utilize the received voltage, or signals provided with the voltage, to control operation of the spotlight and the night vision device. The spotlight/night vision device 340 includes the light 110, a night vision device (thermal camera) 350, a second processor 360, and a communication (wireless) module 370 all within the housing (not shown). The second processor 360 receives the voltage, or signals, provided by the handle 310 via the bar 130 and provides appropriate instructions to the spotlight 110 and the night vision device 350 to control operation thereof. The operation of the spotlight/night vision device 340 may include, for example, only the light 110 on where the light 110 may operate in different modes (e.g., full brightness, reduced brightness, strobe), only the night vision device 350 on, or both on (where light 110 possibly operates in different modes). When the night vision device 350 is on it receives thermal radiation for any objects in the line of sight and creates a video based thereon. The communication module 370 wirelessly communicates the video to a display device (or display devices) 380 located within the vehicle. The display device 380 could be anything selected by a user that is cable of communicating with the spotlight/night vision device 340 (receiving wireless signals from the communication module 370) and displaying the video of the thermal images including, but not limited to, a smart phone, a laptop computer, a tablet computer, a heads-up display, a monitor or an infotainment system of the vehicle. The system 300 does not require an extra cable being connected to the night vision device 350 and allows control of both the spotlight 110 and the night vision device 350 via the handle 310.

The manner in which the user interface 330 is utilized to select a desired state is configurable and depends on the type of user interface implemented. If the user interface 330 is a simple button the manner in which the button is depressed may control the operation. For example, a single press may toggle the night vision device 350 between on and off (depressing when off will turn on and vice versa). A long press of the button may cause the light 110 to toggle through its various states (e.g., switches states after each second the button is depressed). For example, if the order of the states is (1) off, (2) on full strength, (3) on low intensity and (4) strobe, then holding the button will toggle from a current state to the next state and so on. The button may be capable of lighting different colors based on the mood it is in. For example, if the thermal night vision device 350 is on it may be white, if the light 110 is on full strength it may be yellow, if the light 110 is on low intensity it may be green, and if the light 110 is on strobe it may be red. If both are on, then both appropriate colors may be on, or alternatively another set of colors may be used to indicate both.

The above examples are in no way intended to be limiting. Rather they are simply examples of the modes of operation of the spotlight/night vision device 340, how a button user interface 330 may be utilized to select operations of the spotlight/night vision device 340 and how the button user interface 330 may provide an indication of the current state. Different operational modes could be implemented without departing from the current scope. Likewise, different schemes could be utilized to select the operations of the spotlight/night vision device 340 using the button user interface 330 without departing from the current scope. Also, various schemes could be utilized to provide an indication of the current state without departing from the current scope.

The voltage provided based on the operational state may also be configurable. By way of example, if only the night vision device 350 in on the voltage provide may be between 5-6V, if only the light 110 is on full strength the voltage provide may be between 6-7V, if only the light 110 is on low intensity the voltage provide may be between 7-8V, if only the light 110 is on strobe the voltage provide may be between 8-9V, if the night vision device 350 in on and the light 110 is on full strength the voltage provide may be between 9-10V, if the night vision device 350 in on and the light 110 is on low intensity the voltage provide may be between 10-11V, and if the night vision device 350 in on and the light 110 is on strobe the voltage provide may be between 11-12V.

The above examples are in no way intended to be limiting. Rather, different voltage ranges could be utilized without departing from the current scope. Also, other forms of signaling (e.g., PWM) could be utilized without departing from the current scope.

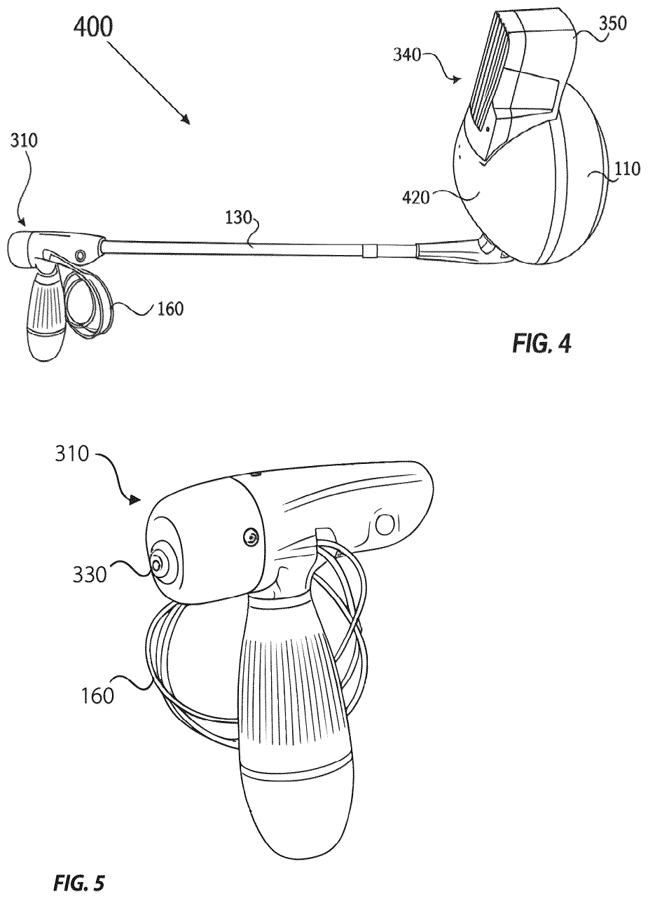

FIG. 4 illustrates an example spotlight and night vision device mounting system 400. The system 400 includes the handle 310 mounted to a first end of the bar 130 and the spotlight/night vision device 340 mounted to a second end of the bar 130. The spotlight/night vision device 340 includes the light 110 and the night vision device (e.g., infrared camera) 350 within an enclosure 420. The handle 310 includes the user interface 330 (not visible) which may be, for example, a button, a switch, or a touch device for controlling operation of the system 400. The power cable 160 is used to provide power to the handle 310.

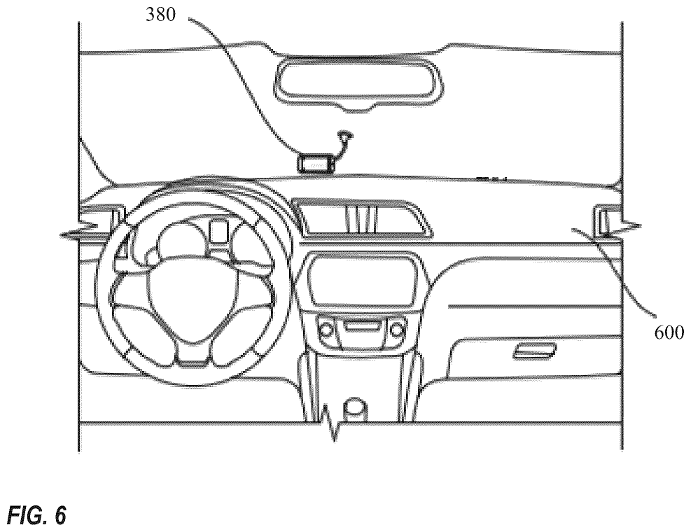

FIG. 5 illustrates an alternative view of the handle 310 where a button is implemented as the user interface 330.

FIG. 6 illustrates a display device 380 mounted in the interior of a vehicle 600 to provide the video of the thermal images captured by the thermal camera 350 to the user. The display device 380 can be any of various devices selected by the user. The display device 380 may be mounted to various locations in the vehicle including, but not limited to, on the dashboard, on the window, to the roof, or to various support members that may be located in the vehicle.

Although the invention has been illustrated by reference to specific embodiments, it will be apparent that the invention is not limited thereto as various changes and modifications may be made thereto without departing from the scope. Reference to “one embodiment” or “an embodiment” means that a particular feature, structure or characteristic described therein is included in at least one embodiment. Thus, the appearances of the phrase “in one embodiment” or “in an embodiment” appearing in various places throughout the specification are not necessarily all referring to the same embodiment.

The various embodiments are intended to be protected broadly within the spirit and scope of the appended claims.

The invention claimed is:

1. A spotlight and night vision device mounting system for a vehicle, the system comprising:
an actuating bar connected to the vehicle and having a first end internal to the vehicle and a second end external to the vehicle, wherein the actuating bar acts as a coaxial shaft to provide a voltage;
a handle located on the first end of the actuating bar, wherein the handle includes a user interface to receive commands from a user and a first processor to provide signals based on the received commands;
an enclosure located on the second end of the actuating bar, wherein the enclosure is to house a spotlight, a night vision device, a second processor and a communications interface, wherein the second processor is to receive the signals from the first processor and control operation of the spotlight and the night vision device based thereon, wherein the night vision device is to detect thermal radiation from one or more objects located in line of sight of the vehicle and create a video stream from the detected thermal radiation from the one or more objects, and wherein the communications interface is to transmit the video stream to a display device located within an interior of the vehicle for viewing by a driver of the vehicle; and
a means for providing power to the handle.

2. The system of claim 1, wherein the night vision device includes a far wave infrared thermal detector for detecting thermal radiation from the one or more objects.

3. The system of claim 2, wherein the far wave infrared thermal detector is a microbolometer.

4. The system of claim 1, wherein the enclosure further comprises a memory configured to store the generated video stream for later retrieval.

5. The system of claim 1, wherein the enclosure is configured to replace portions of a frame of the spotlight in order to secure the night vision camera, the second processor and the communications interface to the spotlight.

6. The system of claim 1, wherein the means for providing power to the handle includes a cable connecting to a power source for the vehicle.

7. The system of claim 1, wherein the user can select the display device from the following: a smart phone, a laptop computer, tablet computer, heads up display, a monitor installed in the vehicle or an infotainment system of the vehicle.

8. The system of claim 1, wherein the display device is mounted inside the vehicle.

9. The system of claim 8, wherein the display device is mounted to one of a dashboard, a window, a roof, a rear-view mirror or a support member of the vehicle.

10. The system of claim 1, wherein the user interface is a button, a switch, or a touch device.

11. The system of claim 1, wherein the user interface provides an indicator regarding operational mode of the system.

12. The system of claim 1, wherein the operation of the spotlight includes on, off and different operational modes.

13. The system of claim 1, wherein the operation of the night vision device includes on and off.

14. The system of claim 1, wherein the first processor provides signals by adjusting the voltage.

15. The system of claim 1, wherein the first processor adds the signals to the voltage provided.

16. The system of claim 14, wherein the signals are added by pulse width modulation.

17. A spotlight and night vision mounting system for a vehicle, the system comprising:
an actuating bar connected to the vehicle and having a first end internal to the vehicle and a second end external to the vehicle, wherein the actuating bar acts as a coaxial shaft to provide a voltage;
a handle located on the first end of the actuating bar, wherein the handle includes
a user interface to receive commands from a user; and
a first processor to provide signals based on the received commands;
an enclosure located on the second end of the actuating bar, wherein the enclosure includes
a spotlight to provide light to illuminate an area around the vehicle;
a thermal detector to detect thermal radiation from one or more objects;
a second processor to receive the signals from the first processor and control operation of the spotlight and the thermal detector based thereon and receive the detected thermal radiation, process the detected thermal radiation, and generate a video stream corresponding to the detected thermal radiation; and
a wireless communication interface to wirelessly transmit the generated video stream to a display device located internal to the vehicle for viewing within the vehicle; and
a means for providing power to the handle.

18. The system of claim 17, wherein the user interface is a button, a switch, or a touch device.

19. The system of claim 17, wherein the first processor provides signals by adjusting the voltage.

20. The system of claim 17, wherein the first processor pulse width modulates the signals onto the voltage.
